(19) United States
(12) Patent Application Publication
(10) Pub. No.: US 2013/0012637 A1
(43) Pub. Date: Jan. 10, 2013

(54) IMPROVED PROCESS FOR FORMING POLYARYLENE SULFIDE FIBERS

(76) Inventors: Joachim C. Ritter, Wilmington, DE (US); Joel M. Pollino, Alpharetta, GA (US); Michael T. Pottiger, Media, PA (US); Lakshmi Krishnamurthy, Wilmington, DE (US); John C. Howe, Bear, DE (US); Harry Vaughn Samuelson, Chadds Ford, PA (US); Marios Avgousti, Kennett Square, PA (US); Zheng-Zheng Huang, Hockessin, DE (US); Robert John Duff, Blue Bell, PA (US)

(21) Appl. No.: 13/636,136

(22) PCT Filed: Mar. 21, 2011
(86) PCT No.: PCT/US11/29167

§ 371 Date: Sep. 20, 2012

Related U.S. Application Data
(60) Provisional application No. 61/316,059, filed on Mar. 22, 2010.

(51) Int. Cl. C08L 81/04; C08K 5/098

(52) U.S. Cl. 524/399

(57) ABSTRACT

An improved process for forming polyarylene sulfide fibers is provided. The process comprises forming at least one fiber from a polymer melt comprising a polyarylene sulfide and at least one tin additive comprising a branched tin(II) carboxylate. Using such a melt, the fiber forming continuity is improved compared to that of the native polyarylene sulfide melt processed under the same conditions.

### CROSS-REFERENCE TO RELATED APPLICATIONS

This application claims the benefit of priority of U.S. Provisional Application No. 61/316,059 filed on Mar. 22, 2010, which is herein incorporated by reference in its entirety.

### FIELD

This invention relates to polyarylene sulfide fibers formed from a polymer melt.

### BACKGROUND

The commercial thermoplastic polymer polyphenylene sulfide (PPS) exhibits limited thermal and thermooxidative stability, which in turn limits its utility in applications where high temperature (for example, greater than about 180° C.) and air are present. Typically, PPS is processed in the melt at about 300° C. or higher through molding and fiber spinning, and partial decomposition can occur, resulting in loss of polymer properties and reduced productivity. During fiber forming operations, material deposits over time near the orifice through which the polymer is extruded. This formation of die deposits interferes with productivity of the fiber forming process and/or product quality because die deposits lead to die drips, which disrupt the fiber forming process. As a result, fiber spinning has to be interrupted frequently to physically remove die deposits in order to prevent die drips. These interruptions significantly increase the cost of fiber manufacture. An additional economic cost and environmental concern is the disposal of the polymer waste that accumulates during removal of the die deposits or when die drips occur.

Literature on die deposit buildup in extrusion processes has been reviewed by J. D. Gander and A. J. Giacomin (Polymer Engineering and Science, July 1997, vol. 37, no. 7, p. 1113-1126.)

Various procedures have been utilized to stabilize polyarylene sulfide compositions such as polyphenylene sulfide (PPS) against changes in physical properties during polymer processing. For example, U.S. Pat. No. 4,411,853 discloses that the heat stability of arylene sulfide resins is improved by the addition of an effective stabilizing amount of at least one organotin compound which retards curing and cross-linking of the resin during heating. A number of dialkyltin dicarboxylate compounds used as cure retarders and heat stabilizers are disclosed, as well as di-n-butyltin-S,S′-bis(isooctyl thioacetate) and di-n-butyltin-S,S′-bis(isooctyl-3-thiopropionate.

U.S. Pat. No. 4,418,029 discloses that the heat stability of arylene sulfide resins is improved by the addition of cure retarders comprising Group IIA or Group IIB metal salts of fatty acids represented by the structure [CH₃(CH₂)ₙCOO—]—₂M, where M is a Group IIA or Group IIB metal and n is an integer from 8 to 18. The effectiveness of zinc stearate, magnesium stearate, and calcium stearate is disclosed.

U.S. Pat. No. 4,426,479 relates to a chemically stabilized poly-p-phenylene sulfide resin composition and a film made thereof. The reference discloses that the PPS resin composition should contain at least one metal component selected from the group consisting of zinc, lead, magnesium, manganese, barium, and tin, in a total amount of from 0.05 to 40 wt %. These metal components may be contained in any form.

U.S. Pat. Nos. 3,405,073 and 3,489,702 relate to compositions useful in the enhancement of the resistance of ethylene sulfide polymers to heat deterioration. Such polymers are composed of ethylene sulfide units linked in a long chain (CH₂CH₂—S)ₙ, where n represents the number of such units in the chain, and are thus of the nature of polymeric ethylene thioethers. The references note that the utility of these polymers as plastic materials for industrial applications is seriously limited, however, due to their lack of adequate mechanical strength. The references disclose that an organotin compound having organic radicals attached to tin through oxygen, such as a tin carboxylate, phenolate or alcoholate, is employed to enhance resistance to heat deterioration of ethylene sulfide polymers. The references note that the efficacy of the organotin compounds is frequently enhanced by a compound of another polyvalent metal, or another tin compound. The second polyvalent metal can be any metal selected from Groups II to VIII of the Periodic Table. Given the different chemical reactivity and physical properties of ethylene sulfide polymers as compared to polyarylene sulfides, it would not be obvious that the same additives would have the same effect in polyarylene sulfides as in ethylene sulfide polymers.

Methods to improve the continuity of polyarylene sulfide fiber formation are desired. In particular, methods to reduce the propensity to form die deposits and to increase the time interval between die drips in the formation of polyarylene sulfide fibers are sought. New chemical approaches to the resolution of the problem of die deposits and the related problem of die drips are needed.

### SUMMARY

This invention provides processes for forming fibers from a polymer melt comprising a polyarylene sulfide and at least one tin additive comprising a branched tin(II) carboxylate as described herein.

In one embodiment, this invention is a process comprising: forming, under suitable conditions, at least one fiber from a polymer melt comprising a polyarylene sulfide and at least one tin additive comprising a a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion; wherein the fiber forming continuity is improved compared to that of the native polyarylene sulfide melt processed under the same conditions.

In one embodiment, the tin additive further comprises a linear tin(II) carboxylate Sn(O₂CR″)₂ and where R″ is a primary alkyl group comprising from 6 to 30 carbon atoms.

In one embodiment, the tin(II) carboxylate comprises Sn(O₂CR)₂, Sn(O₂CR)(O₂CR′), or mixtures thereof, and the radicals R or R′ independently or both have a structure represented by Formula (I),

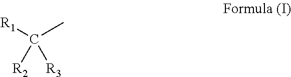

wherein R₁, R₂, and R₃ are independently:

H;

a primary, secondary, or tertiary alkyl group having from 6 to 18 carbon atoms, optionally substituted with fluoride, chloride, bromide, iodide, nitro, hydroxyl, and carboxyl groups;

an aromatic group having from 6 to 18 carbon atoms, optionally substituted with alkyl, fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups;

with the proviso that when R₂ and R₃ are H, R₁ is:

a secondary or tertiary alkyl group having from 6 to 18 carbon atoms, optionally substituted with fluoride, chloride, bromide, iodide, nitro, hydroxyl, and carboxyl groups;

an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups.

In one embodiment, the radicals R or R′ or both have a structure represented by Formula (I), and R₃ is H.

In one embodiment, the tin(II) carboxylate comprises Sn(O₂CR)₂, Sn(O₂CR)(O₂CR′), or mixtures thereof, and the radicals R or R′ or both have a structure represented by Formula (II),

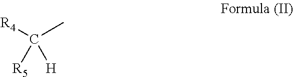

wherein

R₄ is a primary, secondary, or tertiary alkyl group having from 4 to 6 carbon atoms, optionally substituted with fluoride, chloride, bromide, iodide, nitro, and hydroxyl groups; and

R₅ is a methyl, ethyl, n-propyl, sec-propyl, n-butyl, sec-butyl, or tert-butyl group, optionally substituted with fluoride, chloride, bromide, iodide, nitro, and hydroxyl groups.

In one embodiment, the tin(II) carboxylate comprises Sn(O₂CR)₂, and R has a structure represented by Formula (II), where R₄ is n-butyl and R₅ is ethyl.

In one embodiment, the process further comprises combining at least one zinc(II) compound and/or zinc metal with the additive and the polyarylene sulfide. In one embodiment, the zinc(II) compound comprises zinc stearate, the additive comprises Sn(O₂CR)₂, and R has a structure represented by Formula (II)

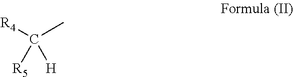

where R₄ is n-butyl and R₅ is ethyl. In one embodiment, the zinc(II) compound and/or zinc metal is present at a concentration of about 10 weight percent or less, based on the weight of the polyarylene sulfide.

In one embodiment, the polyarylene sulfide is polyphenylene sulfide. In one embodiment, the moisture content of the polyarylene sulfide is about 600 ppm or less. In one embodiment, the suitable conditions include a temperature of about 280° C. to about 310° C. In one embodiment, the fiber forming continuity is improved through a reduction in the time to formation of an initial die deposit. In one embodiment, the fiber forming continuity is improved through a reduction in the time to die drip.

This invention relates to improvements in forming polyarylene sulfide fibers. In the improved process, fibers are formed from a polymer melt comprising a polyarylene sulfide and at least one tin additive comprising a branched tin(II) carboxylate. With the use of such a melt, the fiber forming continuity is improved compared to the fiber forming continuity of an additive-free polyarylene sulfide melt processed under the same conditions.

### DETAILED DESCRIPTION

This invention relates to improved processes for forming fibers from a polymer melt comprising a polyarylene sulfide and at least one tin(II) salt of a branched organic carboxylic acid. Using such a melt, the fiber forming continuity is improved compared to the fiber forming continuity of the polyarylene sulfide melt processed under the same conditions but without containing the tin additive.

Where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

Where a range of numerical values is recited herein, unless otherwise stated, the range is intended to include the endpoints thereof, and all integers and fractions within the range. It is not intended that the scope of the invention be limited to the specific values recited when defining a range.

The following definitions are used herein and should be referred to for interpretation of the claims and the specification.

The term “PAS” means polyarylene sulfide.

The term “PPS” means polyphenylene sulfide.

The term “native” refers to a polymer which does not contain any additives.

The term “secondary carbon atom” means a carbon atom that is bonded to two other carbon atoms with single bonds.

The term “tertiary carbon atom” means a carbon atom that is bonded to three other carbon atoms with single bonds.

The term “thermal stability”, as used herein, refers to the degree of change in the weight average molecular weight of a PAS polymer induced by elevated temperatures in the absence of oxygen. As the thermal stability of a given PAS polymer improves, the degree to which the polymer's weight average molecular weight changes over time decreases. Generally, in the absence of oxygen, changes in molecular weight are often considered to be largely due to chain scission, which typically decreases the molecular weight of a PAS polymer.

The term “thermo-oxidative stability”, as used herein, refers to the degree of change in the weight average molecular weight of a PAS polymer induced by elevated temperatures in the presence of oxygen. As the thermo-oxidative stability of a given PAS polymer improves, the degree to which the polymer's weight average molecular weight changes over time decreases. Generally, in the presence of oxygen, changes in molecular weight may be due to a combination of oxidation of the polymer and chain scission. As oxidation of the polymer typically results in cross-linking, which increases molecular weight, and chain scission typically decreases the molecular weight, changes in molecular weight of a polymer at elevated temperatures in the presence of oxygen may be challenging to interpret.

The term “die deposit” refers to the unwanted material, in a polymer extrusion process such as fiber forming, that deposits over time near the orifice through which a polymer is extruded.

The term “die drip” refers to the unwanted phenomenon of a die deposit making physical contact with the extruded polymer exiting an orifice in a polymer extrusion process such as fiber forming.

The term “° C.” means degrees Celsius.

The term “kg” means kilogram(s).

The term “g” means gram(s).

The term “mg” means milligram(s).

The term “mol” means mole(s).

The term “s” means second(s).

The term “min” means minute(s).

The term “hr” means hour(s).

The term “rpm” means revolutions per minute.

The term “cc/rev” means cubic centimeters per revolution.

The term “rad” means radians.

The term “Pa” means pascals.

The term “psi” means pounds per square inch.

The term “mL” means milliliter(s).

The term “ft” means foot.

The term “ppm” means parts per million.

The term “weight percent” as used herein refers to the weight of a constituent of a composition relative to the entire weight of the composition unless otherwise indicated. Weight percent is abbreviated as “wt %”.

This invention provides improved processes for forming fibers from a polymer melt comprising a polyarylene sulfide and at least one tin additive comprising a branched tin(II) carboxylate. The use of such a melt improves the fiber forming continuity compared to that of the polyarylene sulfide melt processed under the same conditions but without the tin additive. Improvement in fiber forming continuity may be quantified, for example, by a reduction in the time to formation of an initial die deposit, or by a reduction in the time interval between the start of fiber formation and the occurrence of a die drip resulting from die deposit buildup. Improvements in fiber forming continuity provide economic advantage through improved process uptime and efficiency.

This invention also provides related improvements to polyarylene sulfide extrusion processes such as film blowing, extrusion coating, blow molding, wire and cable coating, calendaring, injection molding, and injection blow molding, where analogous die deposit buildup may be reduced by using a polyarylene sulfide melt comprising at least one tin additive comprising a branched tin(II) carboxylate.

Polyarylene sulfides (PAS) include linear, branched or cross linked polymers that include arylene sulfide units. Polyarylene sulfide polymers and their synthesis are known in the art and such polymers are commercially available. Polyarylene sulfide fibers are useful in various applications which require superior thermal resistance, chemical resistance, and electrical insulating properties.

Exemplary polyarylene sulfides useful in the invention include polyarylene thioethers containing repeat units of the formula —[(Ar¹)ₙ—X]ₘ—[(Ar²)ᵢY]ⱼ—(Ar³)ₖ—Z]ₗ[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A PPS resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit.

The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

As noted above, PPS is an example of a polyarylene sulfide. PPS is an engineering thermoplastic polymer that is widely used for film, fiber, injection molding, and composite applications due to its high chemical resistance, excellent mechanical properties, and good thermal properties. However, the thermal and oxidative stability of PPS is considerably reduced in the presence of air and at elevated temperature conditions. Under these conditions, severe degradation can occur, leading to the embitterment of PPS material and severe loss of strength. Improved thermal and oxidative stability of PPS at elevated temperatures and in the presence of air are desired. An added benefit of the use of the tin additives described herein, optionally in combination with at least one zinc(II) compound or zinc metal, is the improved thermal and thermo-oxidative stability these additives provide to PPS.

In one embodiment, the process comprises forming, under suitable conditions, at least one fiber from a polymer melt comprising a polyarylene sulfide and at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion. In one embodiment, the branched tin(II) carboxylate comprises Sn(O₂CR)₂, Sn(O₂CR)(O₂CR′), or a mixture thereof. In one embodiment, the branched tin(II) carboxylate comprises Sn(O₂CR)₂. In one embodiment, the branched tin(II) carboxylate comprises Sn(O₂CR)(O₂CR′). In one embodiment, the branched tin(II) carboxylate comprises Sn(O₂CR)(O₂CR″).

Optionally, the tin additive may further comprise a linear tin(II) carboxylate Sn(O₂CR″)₂. Generally, the relative amounts of the branched and linear tin(II) carboxylates are selected such that the sum of the branched carboxylate moieties [O₂CR+O₂CR] is at least about 25% on a molar basis of the total carboxylate moieties [O₂CR+O₂CR′+O₂CR″] contained in the additive. For example, the sum of the branched carboxylate moieties may be at least about 33%, or at least about 40%, or at least about 50%, or at least about 66%, or at least about 75%, or at least about 90%, of the total carboxylate moieties contained in the tin additive.

In one embodiment, the radicals R and R′ both comprise from 6 to 30 carbon atoms and both contain at least one secondary or tertiary carbon. The secondary or tertiary carbon(s) may be located at any position(s) in the carboxylate moieties O₂CR and O₂CR′, for example in the position α to the carboxylate carbon, in the position ω to the carboxylate carbon, and at any intermediate position(s). The radicals R and R′ may be unsubstituted or may be optionally substituted with inert groups, for example with fluoride, chloride, bromide, iodide, nitro, hydroxyl, and carboxylate groups. Examples of suitable organic R and R′ groups include aliphatic, aromatic, cycloaliphatic, oxygen-containing heterocyclic, nitrogen-containing heterocyclic, and sulfur-containing heterocyclic radicals. The heterocyclic radicals may contain carbon and oxygen, nitrogen, or sulfur in the ring structure.

In one embodiment, the radical R″ is a primary alkyl group comprising from 6 to 30 carbon atoms, optionally substituted with inert groups, for example with fluoride, chloride, bromide, iodide, nitro, hydroxyl, and carboxylate groups. In one embodiment, the radical R″ is a primary alkyl group comprising from 6 to 20 carbon atoms.

In one embodiment, the radicals R or R′ independently or both have a structure represented by Formula (I),

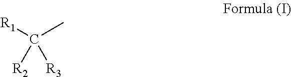

wherein R₁, R₂, and R₃ are independently:

H;

a primary, secondary, or tertiary alkyl group having from 6 to 18 carbon atoms, optionally substituted with fluoride, chloride, bromide, iodide, nitro, hydroxyl, and carboxyl groups;

an aromatic group having from 6 to 18 carbon atoms, optionally substituted with alkyl, fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups;

with the proviso that when R₂ and R₃ are H, R₁ is:

a secondary or tertiary alkyl group having from 6 to 18 carbon atoms, optionally substituted with fluoride, chloride, bromide, iodide, nitro, hydroxyl, and carboxyl groups;

an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups.

In one embodiment, the radicals R or R′ or both have a structure represented by Formula (I), and R₃ is H.

In another embodiment, the radicals R or R′ or both have a structure represented by Formula (II),

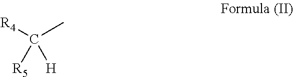

wherein

R₄ is a primary, secondary, or tertiary alkyl group having from 4 to 6 carbon atoms, optionally substituted with fluoride, chloride, bromide, iodide, nitro, and hydroxyl groups; and

R₅ is a methyl, ethyl, n-propyl, sec-propyl, n-butyl, sec-butyl, or tert-butyl group, optionally substituted with fluoride, chloride, bromide, iodide, nitro, and hydroxyl groups.

In one embodiment, the radicals R and R′ are the same and both have a structure represented by Formula (II), where R₄ is n-butyl and R₅ is ethyl. This embodiment describes the branched tin(II) carboxylate tin(II) 2-ethylhexanoate, also referred to herein as tin(II) ethylhexanoate.

The tin(II) carboxylate(s) may be obtained commercially, or may be generated in situ from an appropriate source of tin(II) cations and the carboxylic acid corresponding to the desired carboxylate(s). The tin additive may be present in the polyarylene sulfide at a concentration sufficient to provide improved thermo-oxidative and/or thermal stability. In one embodiment, the tin additive may be present at a concentration of about 10 weight percent or less, based on the weight of the polyarylene sulfide. For example, the tin additive may be present at a concentration of about 0.01 weight percent to about 5 weight percent, or for example from about 0.25 weight percent to about 2 weight percent. Typically, the concentration of the tin additive may be higher in a master batch composition, for example from about 5 weight percent to about 10 weight percent, or higher. The tin additive may be added to the molten or solid polyarylene sulfide as a solid, as a slurry, or as a solution.

In one embodiment, the polyarylene sulfide composition further comprises at least one zinc(II) compound and/or zinc metal [Zn(0)]. The zinc(II) compound may be an organic compound, for example zinc stearate, or an inorganic compound such as zinc sulfate or zinc oxide, as long as the organic or inorganic counter ions do not adversely affect the desired properties of the polyarylene sulfide composition. The zinc(II) compound may be obtained commercially, or may be generated in situ. Zinc metal may be used in the composition as a source of zinc(II) ions, alone or in conjunction with at least one zinc(II) compound. In one embodiment the zinc(II) compound is selected from the group consisting of zinc oxide, zinc stearate, and mixtures thereof.

The zinc(II) compound and/or zinc metal may be present in the polyarylene sulfide at a concentration of about 10 weight percent or less, based on the weight of the polyarylene sulfide. For example, the zinc(II) compound and/or zinc metal may be present at a concentration of about 0.01 weight percent to about 5 weight percent, or for example from about 0.25 weight percent to about 2 weight percent. Typically, the concentration of the zinc(II) compound and/or zinc metal may be higher in a master batch composition, for example from about 5 weight percent to about 10 weight percent, or higher. The at least one zinc(II) compound and/or zinc metal may be added to the molten or solid polyarylene sulfide as a solid, as a slurry, or as a solution.

The zinc(II) compound and/or zinc metal may be added together with the tin additive or separately to the polyarylene sulfide. The zinc and tin compounds may be preblended as a dry mixture with the polyarylene sulfide before melting and extrusion. Alternatively, the zinc and tin compounds may be compounded with the polyarylene sulfide in a masterbatch formulation, then diluted with additional polyarylene sulfide, as dry solids or as melts.

Methods for making polyarylene sulfide fibers are well known and need not be described here in detail. Generally the fibers are prepared using conventional textile fiber spinning processes and apparatus and optionally utilizing mechanical drawing techniques as known in the art. Processing conditions for the melt extrusion and fiber-formation of polyarylene sulfide polymers are well known in the art and may be employed.

To form at least one fiber from a polymer melt comprising a polyarylene sulfide and at least one tin additive, and optionally a zinc(II) compound or zinc metal, as described above, the polymer is melt extruded and fed into a polymer distribution system wherein the polymer is introduced into a spinneret plate. The spinneret is configured so that the extrudant has the desired shape. Suitable conditions for forming fibers include a temperature in the range of about 260° C. to about 350° C., or for example in the range of about 280° C. to about 310° C. The lower limit is generally determined by the temperature at which the polyarylene sulfide composition is sufficiently molten to be processed. The upper limit is generally determined by the acceptable extent of polymer degradation.

Following extrusion through the die, the resulting thin fluid strands, or filaments, remain in the molten state before they are solidified by cooling in a surrounding fluid medium, which may be chilled air blown through the strands, or immersion in a bath of liquid such as water. Once solidified, the filaments are taken up on a godet or another take-up surface. In a continuous filament process, the strands are taken up on a godet which draws down the thin fluid streams in proportion to the speed of the take-up godet. In the jet process, the strands are collected in a jet, such as for example, an air gun, and blown onto a take-up surface such as a roller or a moving belt to form a spunbond web. In the meltblown process, air is ejected at the surface of the spinneret, which serves to simultaneously draw down and cool the thin fluid streams as they are deposited on a take-up surface in the path of cooling air, thereby forming a fiber web.

Regardless of the type of melt spinning procedure which is used, the thin fluid streams are melt drawn down in a molten state, i.e. before solidification occurs to orient the polymer molecules for good tenacity. Typical melt draw down ratios known in the art may be utilized. Where a continuous filament or staple process is employed, it may be desirable to draw the strands in the solid state with conventional drawing equipment, such as, for example, sequential godets operating at differential speeds.

Following drawing in the solid state, the continuous filaments may be crimped or texturized and cut into a desirable fiber length, thereby producing staple fiber. The length of the staple fibers generally ranges from about 25 to about 50 millimeters, although the fibers can be longer or shorter as desired.

The fiber can be staple fibers, continuous filaments, or meltblown fibers. In general, the staple and spunbond fibers formed in accordance with the improved process can have a fineness of about 0.5 to about 100 denier. Meltblown filaments can have a fineness of about 0.001 to about 10.0 denier. The fibers can also be monofilaments, which can have a fineness ranging from about 20 to about 10,000 denier.

PPS Fibers or nonwoven fabrics comprising such fibers are useful, for example, in filtration media employed at elevated temperatures, as in filtration of exhaust gas from incinerators or coal fired boilers with bag filters.

### EXAMPLES

This invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Materials

The following materials were used in the examples. All commercial materials were used as received unless otherwise indicated. Fortron® 309 polyphenylene sulfide and Fortron® 317 polyphenylene sulfide were obtained from Ticona Inc. (Florence, Ky.) as pellets.) Tin(II) 2-ethylhexanoate (90%) and zinc oxide (99%) were obtained from Sigma-Aldrich (St. Louis, Mo.). Tin(II) stearate (98%) was obtained from Acros Organics (Morris Plains, N.J.). Zinc stearate (99%) was obtained from Honeywell Reidel-de Haen (Seelze, Germany).

Tin(II) 2-ethylhexanoate is also referred to herein as tin(II) ethylhexanoate.

### Analytical Methods

Moisture content of the Fortron® PPS resins was determined by Karl-Fischer titration.

Die deposit observations were made visually while the die face was illuminated by a high intensity lamp. The observer would stand about one foot away from the die during fiber spinning and visually inspect the die face every few minutes for die deposits. For a given sample, the observation of die deposits was made by the same individual throughout fiber spinning. Most samples were observed by the same individual. Time to initial die deposit was measured as the time elapsed from when the spin pack was positioned in place and polymer began flowing through the die. Typically, the initial die deposit was observed to form on one, two, or three holes, then with longer elapsed time additional die deposits were observed to form on other holes in the die face. The “time to initial die deposit” values reported in Table 1 with an approximation sign “˜” preceding the value are estimated to have an error of about +/−5 minutes.

In the Comparative Examples and Examples, fibers were formed at a temperature of 330° C. Typically, lower temperatures are preferred for fiber forming, in order to minimize any polymer degradation which might occur during processing. The higher temperature was selected for the experimental runs in order to provide harsher test conditions as a way to accelerate the formation of any die deposits and the ensuing die drips.

In the Table, “Ex” means “Example”, “Comp Ex” means “Comparative Example”, “wt %” means “weight percent”, and “NA” means “not applicable”.

### Comparative Example A

This Comparative Example is a control showing the results of using dried polyphenylene sulfide without an additive. Fortron® 317 and Fortron® 309 resins were both dried overnight at 100° C. under vacuum (15-20 inches of Hg with a small nitrogen bleed to remove any volatiles) to reduce the moisture content to below 500 ppm. The resins were then combined, 30 parts by weight of dried Fortron® 317 pellets with 70 parts by weight of dried Fortron® 309 pellets, in a plastic bag and shaken for about two minutes to obtain the blend. Typically, the total amount of the blend was in the range of 1 pound to 10 pounds.

The polymer blend was then melted in a 16 mm PRISM twin screw extruder at 330° C. and extruded through a spin pack consisting of twelve holes. The melt pump was set at 0.58 cc/rev. The spin pack consisted of 50/325 mesh screen pack, with 12 die holes each of 14 mils diameter, with a length to diameter ratio of 4:1.

The flow rate of the molten polymer was set to 1 g/minute/hole. The face of the die was visually inspected during the run to determine the formation of die deposits. The time to initial die deposit is reported in Table 1.

### Comparative Example B

This Comparative Example is a control showing the results of using a polyphenylene sulfide composition without an additive. The blended PPS was prepared, melted, and extruded as described for Comparative Example A, except that the Fortron® 317 and Fortron® 309 resins were used as received, without drying. Typical moisture content of blended resins was found to be about 1200 ppm. The time to initial die deposit is reported in Table 1.

### Comparative Example C

This Comparative Example shows the results of using a polyphenylene sulfide composition containing 1 wt % zinc stearate, based on the weight of PPS. A PPS composition was prepared, melted, and extruded as described for Comparative Example B, except that one part by weight of zinc stearate was combined with the 99 parts by weight of the blended polymer. The batch size for preparing the feed was between one and ten pounds. The time to initial die deposit is reported in Table 1.

### Comparative Example D

This Comparative Example shows the results of using a polyphenylene sulfide composition containing 1 wt % zinc stearate. A PPS composition was prepared, melted, and extruded as described for Comparative Example A, except that one part by weight of zinc stearate 99 parts by weight of the “dried” blended polymer. The time to initial die deposit is reported in Table 1.

### Comparative Example E

This Comparative Example shows the results for using a polyphenylene sulfide composition containing 0.5 wt % zinc stearate. A PPS composition was prepared, melted, and extruded as described for Comparative Example A, except that half a part of zinc stearate by weight was combined with 99.5 parts by weight of the “dried” blended polymer. The time to initial die deposit is reported in Table 1.

### Comparative Example F

This Comparative Example shows the results for using a polyphenylene sulfide composition containing 1 wt % zinc stearate and prepared using a preblended composition of zinc stearate and PPS. Fortron® 317 and Fortron® 309 resins were both dried overnight at 100° C. under vacuum with a small nitrogen bleed to reduce the moisture content to below 500 ppm. The PPS composition containing 1 weight percent zinc stearate was produced by the extrusion process. Fortron® 309 PPS (70 parts), Fortron® 317 PPS (30 parts), and Zinc Stearate (1 part) was combined in a glass jar, manually mixed, and placed on a Stoneware bottle roller for 5 min. The resultant mixture was subsequently melt compounded using a Coperion 18 mm intermeshing co-rotating twin-screw extruder. Vacuum port was used to remove the volatiles. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram.

The pelletized composition was then melted in a 16 mm PRISM twin screw extruder at 330° C. and extruded through a spin pack consisting of twelve holes. The flow rate of the molten polymer was set to 1 g/minute/hole. The face of the die was visually inspected during the run to determine the formation of die deposits. The time to initial die deposit is reported in Table 1.

### Comparative Example G

This Comparative Example shows the results for using a polyphenylene sulfide composition containing 1 wt % zinc stearate and prepared using a preblended composition of zinc stearate and PPS. Fortron® 317 and Fortron® 309 resins were both dried overnight at 100° C. under vacuum with a small nitrogen bleed to reduce the moisture content to below 500 ppm. The PPS blend with zinc stearate was prepared as for Comparative Example F, except that the vacuum was not applied to remove the volatiles during the compounding.

The pelletized composition was then melted in a 16 mm PRISM twin screw extruder at 330° C. and extruded through a spin pack consisting of twelve holes. The flow rate of the molten polymer was set to 1 g/minute/hole. The face of the die was visually inspected during the run to determine the formation of die deposits. The time to initial die deposit is reported in Table 1.

### Comparative Example H

This Comparative Example shows the results for using a polyphenylene sulfide composition containing 1 wt % zinc stearate and prepared using a masterbatch method of adding the zinc stearate. The PPS masterbatch composition containing 10 weight percent zinc stearate was produced by the extrusion process. Fortron® 309 PPS (90 parts) was fed to a Coperion 18 mm intermeshing co-rotating twin-screw extruder. 10 parts zinc stearate were added to the extruder using an additive feeder. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram.

The 10% masterbatch of zinc stearate was then diluted to 1% zinc stearate as follows: 10 parts of the masterbatch composition were combined with 60 parts Fortron® 309 and 30 Parts Fortron® 317 as in Comparative Example A and fed to the PRISM extruder. The time to initial die deposit is reported in Table 1.

### Example 1

This Example shows the results for using a polyphenylene sulfide composition containing 0.5 wt % tin(II) ethylhexanoate, based on the weight of PPS. A PPS composition was prepared, melted, and extruded as described for Comparative Example F, except that instead of zinc stearate half a part by weight of tin(II) ethylhexanoate was used. The time to initial die deposit is reported in Table 1.

### Example 2

This Example shows the results for using a polyphenylene sulfide composition containing 0.5 wt % tin(II) ethylhexanoate. A PPS composition was prepared, melted, and extruded as described for Comparative Example C, except that 0.5 parts by weight of tin(II) ethyl hexanoate were combined with the Fortron® 309 PPS (70 parts) and Fortron 317® PPS 30 parts. The time to initial die deposit is reported in Table 1.

### Example 3

This Example shows the results for using a polyphenylene sulfide composition containing 0.5 wt % tin(II) ethylhexanoate. A PPS composition was prepared, melted, and extruded as described for Comparative Example D, except that 0.5 parts by weight of tin(II) ethyl hexanoate were combined with the Fortron® 309 PPS (70 parts) and Fortron 317® PPS (30 parts). The time to initial die deposit is reported in Table 1.

### Example 4

This Example shows the results for using a polyphenylene sulfide composition containing 0.5 wt % tin(II) ethylhexanoate. 35 Parts Fortron® 309 as received were combined with 35 parts dried Fortron® 309, 15 parts as received Fortron® 317, 15 parts dried Fortron® 317, and half a part tin(II) ethylhexanoate in a bag. The measured moisture content of the polymer blend was 546 ppm. The polymer blend was then melted in a 16 mm PRISM twin screw extruder at 330° C. and extruded through a spin pack consisting of twelve holes. The flow rate of the molten polymer was set to 1 g/minute/hole. The face of the die was visually inspected during the run to determine the formation of die deposits. The time to initial die deposit is reported in Table 1.

### Example 5

This Example shows the results for using a polyphenylene sulfide composition containing tin(II) ethylhexanoate. 7 Parts Fortron® 309 as received were combined with 63 parts dried Fortron® 309, 3 parts as received Fortron® 317, 27 parts dried Fortron® 317, and half a part tin(II) ethylhexanoate in a bag. The measured moisture content of the polymer blend was 207 ppm. The polymer blend was then melted in a 16 mm PRISM twin screw extruder at 330° C. and extruded through a spin pack consisting of twelve holes. The flow rate of the molten polymer was set to 1 g/minute/hole. The face of the die was visually inspected during the run to determine the formation of die deposits. The time to initial die deposit is reported in Table 1.

### Example 6

This Example shows the results for using a polyphenylene sulfide composition containing 0.33 wt % tin(II) ethylhexanoate and 0.66 wt % zinc stearate. A PPS composition was prepared, melted, and extruded as described for Comparative Example A, except that 0.33 parts of tin(II) ethylhexanoate and 0.66 parts of zinc stearate were combined with Fortron® 309 (70 parts) and Fortron 317® (30 parts) in a bag. The polymer blend was then melted in a 16 mm PRISM twin screw extruder at 330° C. and extruded through a spin pack consisting of twelve holes. The flow rate of the molten polymer was set to 1 g/minute/hole. The face of the die was visually inspected during the run to determine the formation of die deposits. The time to initial die deposit is reported in Table 1.

TABLE 1
Summary of PPS Drying Conditions, Additive, Loading, Method
of Combining, and Time to Initial Die Deposit for Comparative
Examples A through H and Examples 1 through 6.

| | | Method Used | | | |
|---|---|---|---|---|---|
| | Additive | to Combine | | Time to | |
| | (loading, | PPS and | PPS Drying | Initial Die | |
| Example | wt %) | Additive(s) | Conditions | Deposit | |
| Comp Ex A | None | NA | 100° C. | ~15 | min |
| | (control) | | Vacuum for | | |
| | | | 16 hrs | | |
| Comp Ex B | None | NA | No Drying | ~15 | min |
| | (control) | | | | |
| Comp Ex C | Zinc | melt | No Drying | ~15 | min |
| | Stearate | | | | |
| | (1%) | | | | |
| Comp Ex D | Zinc | melt | 100° C. | ~45 | min |
| | Stearate | | Vacuum for | | |
| | (1%) | | 16 hrs | | |
| Comp Ex E | Zinc | melt | 100° C. | ~15-30 | min |
| | Stearate | | Vacuum for | | |
| | (0.5%) | | 16 hrs | | |
| Comp Ex F | Zinc | Preblended | 100° C. | ~15-30 | min |
| | Stearate | with drying | Vacuum for | | |
| | (1%) | under vacuum | 16 hrs | | |
| Comp Ex G | Zinc | Preblended | 100° C. | ~45 | min |
| | Stearate | without drying | Vacuum for | | |
| | (1%) | under vacuum | 16 hrs | | |
| Comp Ex H | Zinc | Masterbatch | 100° C. | ~45 | min |
| | Stearate | (10%) | Vacuum for | | |
| | (1%) | | 16 hrs | | |
| Ex 1 | Tin(II) | preblended | 100° C. | ~30 | min |
| | ethyl- | | Vacuum for | | |
| | hexanoate | | 16 hrs | | |
| | (0.5%) | | | | |
| Ex 2 | Tin(II) | melt | No Drying | ~ 20 | min |
| | ethyl- | | | | |
| | hexanoate | | | | |
| | (0.5%) | | | | |
| Ex 3 | Tin(II) | melt | 100° C. | Greater than | |
| | ethyl- | | Vacuum for | 2 hrs* | |
| | hexanoate | | 16 hrs | | |
| | (0.5%) | | | | |
| Ex 4 | Tin(II) | melt | 50% Dry + | ~ 1 | hr |
| | ethyl- | | 50% as | | |
| | hexanoate | | received | | |
| | (0.5%) | | | | |

| | | | | |
|---|---|---|---|---|
| Ex 5 | Tin(II) | melt | 90% Dry + | Greater than |
| | ethyl- | | 10% as | 2 hrs* |
| | hexanoate | | received | |
| | (0.5%) | | | |
| Ex 6 | Tin(II) | melt | 100° C. | Greater than |
| | ethyl- | | Vacuum for | 1 hr* |
| | hexanoate | | 16 hrs | |
| | (0.33%) + | | | |
| | Zinc | | | |
| | Stearate | | | |
| | (0.66%) | | | |

*No die deposits were observed in these cases, and the spinning operations were halted after the indicated amount of time had elapsed.

The results show that using a PPS composition comprising tin(II) ethylhexanoate in a process for forming at least one polyphenylene sulfide fiber provides a significant increase in the time to formation of the initial die deposit, as compared to use of the PPS composition without the tin additive. Use of a tin(II) ethylhexanoate-containing PPS composition which further comprises zinc stearate also increases the time to formation of the initial die deposit. The effectiveness of the additives is improved with the use of PPS having a lower moisture content, for example less than about 600 ppm moisture.

Although particular embodiments of This invention have been described in the foregoing description, it will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

What is claimed is:

1. A process comprising: forming at least one fiber from a polymer melt comprising a polyarylene sulfide and at least one tin additive comprising a a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion.

2. The process of claim 1, wherein the tin additive further comprises a linear tin(II) carboxylate Sn(O₂CR″)₂ and where R″ is a primary alkyl group comprising from 6 to 30 carbon atoms.

3. The process of claim 1, wherein the tin(II) carboxylate comprises Sn(O₂CR)₂, Sn(O₂CR)(O₂CR′), or mixtures thereof, and the radicals R or R′ independently or both have a structure represented by Formula (I), 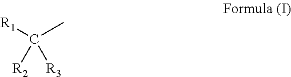
wherein R₁, R₂, and R₃ are independently:
H,
a primary, secondary, or tertiary alkyl group having from 6 to 18 carbon atoms, optionally substituted with fluoride, chloride, bromide, iodide, nitro, hydroxyl, and carboxyl groups;
an aromatic group having from 6 to 18 carbon atoms, optionally substituted with alkyl, fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups;
with the proviso that when R₂ and R₃ are H, R₁ is:
a secondary or tertiary alkyl group having from 6 to 18 carbon atoms, optionally substituted with fluoride, chloride, bromide, iodide, nitro, hydroxyl, and carboxyl groups;
an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups.

4. The process of claim 1, wherein the radicals R or R′ or both have a structure represented by Formula (I), and R₃ is H.

5. The process of claim 1, wherein the tin(II) carboxylate comprises Sn(O₂CR)₂, Sn(O₂CR)(O₂CR′), or mixtures thereof, and the radicals R or R′ or both have a structure represented by Formula (II), 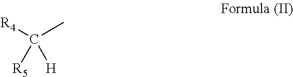
wherein
R₄ is a primary, secondary, or tertiary alkyl group having from 4 to 6 carbon atoms, optionally substituted with fluoride, chloride, bromide, iodide, nitro, and hydroxyl groups; and
R₅ is a methyl, ethyl, n-propyl, sec-propyl, n-butyl, sec-butyl, or tert-butyl group, optionally substituted with fluoride, chloride, bromide, iodide, nitro, and hydroxyl groups.

6. The process of claim 1, wherein the tin(II) carboxylate comprises Sn(O₂CR)₂, and R has a structure represented by Formula (II), where R₄ is n-butyl and R₅ is ethyl.

7. The process of claim 1, further comprising combining at least one zinc(II) compound and/or zinc metal with the additive and the polyarylene sulfide.

8. The process of claim 7, wherein the zinc(II) compound comprises zinc stearate, the additive comprises Sn(O₂CR)₂, and R has a structure represented by Formula (II) 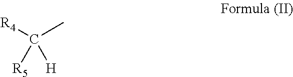
where R₄ is n-butyl and R₅ is ethyl.

9. The process of claim 7, wherein the zinc(II) compound and/or zinc metal is present at a concentration of about 10 weight percent or less, based on the weight of the polyarylene sulfide.

10. The process of claim 1, wherein the polyarylene sulfide is polyphenylene sulfide.

11. The process of claim 1, wherein the moisture content of the polyarylene sulfide is about 600 ppm or less.

12. The process of claim 1, wherein the suitable conditions include a temperature of about 280° C. to about 310° C.

13. The process of claim 1, wherein the fiber forming continuity is improved through a reduction in the time to formation of an initial die deposit.

14. The process of claim 1, wherein the fiber forming continuity is improved through a reduction in the time to die drip.

15. The process of claim 1, wherein the fiber forming continuity is improved compared to that of the native polyarylene sulfide melt processed under the same conditions.
